(19) United States
(12) Patent Application Publication
(10) Pub. No.: US 2008/0099104 A1
(43) Pub. Date: May 1, 2008

(54) Multi-Function Workbench with Wireless controls

(76) Inventor: Anthony A. Bradley, Hickory, NC (US)

Correspondence Address: SIMMONS PATENTS, P.O. BOX 1560, LENOIR, NC, 28645, US

(21) Appl. No.: 11/539,668

(22) Filed: Oct. 9, 2006

(51) Int. Cl. B27C 5/00; B25H 1/00

(52) U.S. Cl. 144/286.5; 144/134.1

(57) ABSTRACT

The present invention relates to a workbench apparatus for routing and shaping work pieces. The workbench includes a top comprising two opposed faces with a motor support structure associated with one face for holding a motor configured to receive one of a router element and a shaping element. The top is pivotally associated with a top support structure thereby allowing the workbench to be selectably positioned in at least one of two work mode configurations. The top dimensions and support structure configuration is selected so that a work piece may be moved across the top surface without interference for the support structure. The motor support structure is configured for a minimum vertical profile while providing motor movement relative to the work piece. The system may further comprise wireless technology for controlling the motor movement. The workbench apparatus without the routing support structure can be used for attaching and storing a plurality of devices.

### TECHNICAL FIELD OF THE INVENTION

The present invention relates to a workbench configured for routing and shaping work pieces and the efficient storage of work tools.

### BACKGROUND OF THE INVENTION

Various types of workbenches and work support structures are known in the art of shaping and routing work pieces using tools associated with a motor. Many prior art configurations provide the ability for detaching the motor apparatus from the workbench and reattaching the motor apparatus at a second location thereby providing multiple functions. One example of such prior art designs is described in U.S. Pat. No. 1,718,275 issued to R. L. Carter. Such prior art device are generally constructed from massive cast iron components making them relatively expensive and heavy, and thus, relatively awkward to use. Additionally, such prior devices comprise support structures that are not optimized for pin router application.

In more recent years new workbench configurations have been developed comprising a top that is pivotally mounted to a frame and used in conjunction with tools such as a table saw. One such example is a woodworking bench described in U.S. Pat. No. 4,465,114 issued to Schumacher and such patent is incorporated by this reference for all purposes. The Schumacher workbench also has several design issues that limit its usefulness for use as a pin router. For example, while the top is pivotally associated with a frame providing for two work surfaces, the top face of at least one work surface is positioned at height that is lower than the frame supports when rotated into position. Thus, the work piece cannot easily be moved across the entire surface of such a work surface as the work piece will come in contact with the frame support. The ability to use the entire work surface area is highly desirable for pin router systems.

In recent years, many types of workbenches comprising under table routers have become available to small woodworking shops and hobbyists. Such devices often comprise lifts, jacks and adjustment mechanisms for moving the router apparatus, but such systems still do not provide sufficient versatility or maximize work shop space utilization effectively.

What is needed is a multi-function workbench capable of performing a wide variety of routing and shaping operations while maximizing work shop space utilization efficiency.

Additionally, many routing applications require the router motor to be movable relative to the motor support structure so that the router tool may be moved into the work piece (e.g. plunge) and retracted from the work piece. Many prior art routing plunge mechanisms have been developed to perform such functions; however, such mechanisms typically have an undesirably large vertical profile. Such large vertical profile greatly complicates or makes it impossible to flip the top to a second configuration where the systems become an under table router/shaper. What is needed is a motor movement mechanism with a minimized vertical profile.

Another short coming of prior art systems having motor movement mechanisms concerns the movement activation apparatus. Typically, prior art pneumatic systems include a foot pedal associated with both mechanical linkage and/or an air source such as an air compressor. When a user desires to invoke a movement, the user presses the foot pedal with his foot thereby allowing air to flow to a pneumatic device that moves the router motor (for example). Such activation apparatus' have worked well in the past but they do have their shortcomings. First, a user often becomes preoccupied with the foot pedal location taking attention away from the task at hand. Second, the user places less pressure on the foot operating the foot pedal than the he places on the opposite foot. Thus, a user may feel like he has been standing on one leg the entire time he is using the system as that leg becomes fatigued faster than the leg operating the foot pedal. Consequently, improvements to such activation apparatus' are needed to make them more user friendly and ultimately improving operator safety.

### SUMMARY

Some of the objects and advantages of the invention will now be set forth in the following description, while other objects and advantages of the invention may be obvious from the description, or may be learned through practice of the invention.

Broadly speaking, a principle object of the present invention is to provide a combined routing and shaping tool comprising a work bench, a motor support structure associated with a motor wherein the workbench may be placed in plurality of work positions so that the tool may be used as both an over arm pin router and an under table router/shaper for precision machining of a work piece without requiring the motor unit to be repositioned.

Yet another object of the invention is to provide a workbench having a plurality of work surfaces that are higher than the workbench top support structure so that the work piece being machined may be moved over the entirety of the work surface.

Still another object of the invention is to provide for an adjustable motor support structure that has a low vertical profile and provides for adjusting the distance between a motor associated with the support structure and a work surface.

A still further object of the invention is to provide a wireless motor adjustment system that comprises a wireless portable transmitter operatively associated with a motor movement system so that a user may control the motor movements using said portable transmitter.

Another object of the invention is to provide a work bench configured to simultaneously receive a plurality of work tools on a plurality of work surfaces thereby maximizing work space utilization efficiency.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

One exemplary embodiment of the present invention relates to an apparatus for routing and shaping a work piece comprising novel implementations of wireless electronic technology associated with novel mechanical configurations for a workbench. The apparatus comprises a top defining a pair of opposed faces, each said face defining a substantially flat plane, each said plane being substantially parallel to the other, said top further defining a peripheral edge connecting said opposed faces. The top is pivotally associated with a first top rail at a first peripheral edge location that is about half way between said opposed faces. The top is also associated with a second top rail at a second peripheral edge location that is about half way between said opposed faces. Each top rail is associated with at least one support leg where each support leg is substantially equal in height. For embodiments where the top rail is associated with only one support leg, such a support structure may form a one-support-let “T” configuration as described later. For embodiments where the top rail is associated with two support legs, such a support structure may form an upside down “U” configuration as describe later.

The pivotal association between the top and the top rails allow the top to be selectably positioned in at least one of a first work position and a second work position. For the first work position, the substantially flat plane defined by one of said opposing faces is substantially parallel to a top rail and higher than said top rail. For the second work position, the substantially flat plane defined by the other face is substantially parallel to said top rail and higher than said top rail.

The top further defines a support plate opening configured for releasably receiving a support plate recessed into one of said faces. For some embodiments, the support plate may also be received by the support plate opening associated with the other face of said top.

The apparatus further comprises a support plate releasably associated with said support plate opening, said support plate comprising one of (a) a template guide pin and (b) a predefined opening configured for releasably receiving a template guide pin. Such a configuration allows a plurality of template guide pin configurations to be used with the apparatus. A template guide bushings may also be used in “under table position” allowing a template to contact the guide bushing outside diameter while a smaller diameter router bit can perform a cutting action on the work piece without the necessity of a bearing installed n the router bit. Template guide bushings are well known by those skilled in the art and a detailed description thereof is not necessary for purposes of describing the method and system according to the present invention.

This embodiment of the invention further comprises a motor support structure associated with a face of said top, said motor support structure comprising a support arm. A motor bracket is movably associated with the support arm. The support arm is substantially parallel to said face and extends to a vertical alignment point with the support plate opening. A motor is associated with said motor bracket wherein the motor is configured for receiving at least one of a routing element and a shaping element. One possible vertical alignment point is the point where the motor shaft for said motor is in alignment with the support plate opening.

A motor bracket adjustment system is associated with the motor bracket and the support arm, said motor bracket adjustment system configured for varying the distance between said motor bracket and said top. For one embodiment of the invention, substantially all of the motor bracket adjustment system is enclosed in said support arm to minimize the vertical profile of the motor support structure and motor bracket adjustment combination.

The apparatus may further comprise a spring loaded indexing pin configured for releasably holding said top in a desired work position. The spring loaded indexing pin comprises a rod extending through a top rail with a first end of the rod being received by the peripheral edge of said top, and wherein the second end of said rod is associated with a handle. The spring loaded indexing pin is biased toward said peripheral edge thereby tending to maintain said top in a locked mode. The top is placed in an unlocked mode by pulling said handle thereby moving said first end away from said peripheral edge. When in the unlocked mode, the workbench may be moved to a different work position. Alternatively, a threaded indexing pin may be used for releasably holding the top in a work position. The threaded indexing pin comprises a threaded rod extending through said first top rail with a first end of the rod being received by the peripheral edge of the top. The second end of said rod is associated with a handle wherein the top is placed in a locked mode by turning said handle in a first direction until said first end of said threaded indexing pin is received by said peripheral edge and wherein the top is placed in an unlocked mode by turning said handle in a second direction until said first end of said threaded indexing pin is moved away from said peripheral edge. Additionally, the peripheral edge is further configured to receive said threaded indexing pin when the top is pivoted to the second work position.

The motor bracket adjustment system comprises a controller electrically associated with a portable transmitter. The controller includes a receiver configured for receiving a signal from said portable transmitter. The portable transmitter may be associated with a work piece carrier, a user, a work piece template or any other suitable object. The portable transmitter technology and said receiver technology may be comprised of any suitable technology such as Bluetooth, Zigbee, and Wi-Fi (wireless fidelity) technology. A processing device is electrically associated with said receiver and configured for generating adjustment signals.

The controller may further comprise a signaling device electrically associated with said processing device, said signaling device comprising at least one of (a) a light emitting element, and (b) a sound emitting element. For this configuration, the processing device is preferably configured to activate the signaling device upon receiving a signal from the portable transmitter. The processing device may be configured to wait a predefined period of time after receiving a signal from said portable transmitter before generating said adjustment signals, thereby providing a warning that the motor bracket adjustment system is about to be engaged.

The motor bracket adjustment system may further comprise a display electrically associated with said processing device. The display may be used for displaying any type of information including elapsed time for a particular job, motor bracket position settings, bit temperature, room temperature, and tool speed.

A motor bracket mover device electrically associated with said processing device and mechanically associated with said motor bracket. For this embodiment of the invention, the motor bracket mover device is configured for adjusting the distance between said motor bracket and said top in response to the adjustment signals generated by the processor. The motor bracket mover device may comprise a pneumatic cylinder comprising a first pneumatic connection, a second pneumatic connection, wherein said pneumatic cylinder is mechanically associated with the motor bracket. An electronic pneumatic switching device is electrically associated with said processing device and pneumatically associated with said first pneumatic connection, said second pneumatic connection, and an air source. The electronic pneumatic switching device is configured for selectively connecting the air source to one of said first pneumatic connection and said second pneumatic connection in response to the adjustment signals generated by the processing device.

The motor bracket adjustment system may further comprise a motor bracket movement limiter for limiting the movement of the motor bracket. The motor bracket movement limiter is mechanically associated with the bracket mover device and electrically associated with said processing device. One example of a motor bracket movement limiter is a series of vertical pins having different heights and installed within a turret device. The motor bracket includes a motor bracket stop that is in alignment with one of the vertical pins and comes in contact with such pin when the motor bracket is moved far enough thereby limiting the motor bracket movement. When more movement is desired, a shorter pin placed in alignment with the motor bracket stop. The motor bracket movement limiter has a plurality of electronically (using electronics) or mechanically selectable movement limit settings (i.e. a plurality of pins in the above example). For the preferred embodiment, the motor bracket movement limiter setting is determined by adjustment signals generated by the processing device. Additionally, any one of the controller, motor bracket, and motor bracket movement system may comprise a display configured for indicating the motor bracket movement limiter setting.

Yet another embodiment of the invention relates to a workbench comprising a top defining a pair of opposed faces, each said face defining a substantially flat plane, each said plane being substantially parallel to the other, said top further defining a peripheral edge connecting said opposed faces. At least two upper support legs, each upper support leg having a first end and a second end are associated with a top rail. A first top rail associated with the first end of a first upper support leg and a second top rail associated with the first end of a second upper support leg. The top is pivotally associated with the first top rail at a first peripheral edge location that is about half way between said opposed faces. The top is also pivotally associated with the second top rail at a second peripheral edge location that is about half way between said opposed faces. The top is selectably positionable in at least one of a first work position and a second work position.

When in the first work position, the substantially flat plane defined by one of said opposing faces is substantially parallel to a top rail and higher than said top rail. When in the second work position, the substantially flat plane defined by the other face is substantially parallel to said top rail and higher than said top rail when said top is in said second work position.

The top further comprises a support plate opening defining a hole through the top. The support plate opening is configured for releasably receiving a support plate. A support plate is releasably associated with the support plate opening and comprises one of (a) a template guide pin, (b) a template guide pin assembly, (c) a template guide bushing, and (d) a predefined opening configured for releasably receiving a template guide pin.

The workbench may further comprise a first lower support leg and a second lower support leg with each support leg having a first end and a second end. The first end of the first lower support leg is associated with the second end of the first upper support leg in a telescopic arrangement. Similarly, the first end of the second lower support leg is associated with the second end of the second upper support leg in a telescopic arrangement. At least one lower support leg and upper support leg pair further comprises at least one locking point for adjusting the height of said top.

The work bench may further comprise a lower surface defining a pair of opposed faces, each said face defining a substantially flat plane, each said plane being substantially parallel to the other, said lower surface further defining a peripheral edge connecting said opposed faces. The lower surface is associated with said lower support legs so that the faces of said lower surface are substantially parallel to faces of said top when said top is positioned in the first work position and the second work position. The lower surface may further define the top of at least one storage bin positioned between said lower surface and said second ends of said lower support legs.

A still further embodiment of the invention relates to a wireless motor movement controller for a motor associated with a workbench. For this embodiment of the invention, the wireless motor movement controller comprises a portable transmitter configured for receiving user input and transmitting control signals in response to said user input. The wireless motor movement controller further comprises a motor support structure having a workbench interface configured for associating the motor support structure to the top of a workbench. A motor bracket configured for receiving a motor is moveably associated with the motor support structure.

The motor bracket is further associated with a motor bracket mover system comprising a force-to-movement-converter. The force-to-movement-converter is configured for receiving a substance that flows into the force-to-movement-converter thereby creating a force that is converted into a movement that moves said motor bracket in one of a plurality of directions and wherein the direction of movement is determined by the flow path. For one embodiment of the wireless motor movement controller, the motor bracket mover system comprises a chain in mechanical communication with said force-to-movement-converter and the motor bracket. The substance flowing into the force-to-movement-converter may be electrons (e.g. electrical motor), gas (e.g. a pneumatic system), and a fluid (e.g. a hydraulic system).

The wireless motor movement controller further comprises a processing device associated with a receiver configured for receiving said control signals transmitted by the portable transmitter. The processing device is configured for generating motor bracket adjustment signals in response to at least part of said control signals. The processing device is further electrically associated with a flow controller wherein said flow controller is associated with a source for providing said substance and wherein the flow controller is configured for controlling the flow of said substance in response to motor bracket adjustment signals generated by the said processing device.

The wireless motor movement controller may further comprise a signaling device electrically associated with said processing device, said signaling device comprising at least one of (a) a light emitting element, and (b) a sound emitting element. The processing device may be further configured to activate the signaling device upon receiving a signal from said portable transmitter and then wait a predefined period of time after activating said signaling device before generating said motor bracket adjustment signals adjustment signals. Preferably the portable transmitter technology and said receiver technology comprise one of (a) Bluetooth technology and (b) Wi-Fi technology with the controller having a display configured for displaying system information.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a front perspective view of a workbench according to one embodiment of the invention with the workbench top in a first work position;

FIG. 2 is a front perspective view of the workbench in FIG. 1 with the workbench top in a second work position;

FIG. 3 is a side view of a workbench according to one embodiment of the invention comprising a lower storage area;

FIG. 4 is a side view of a top rail configured to telescopically associate with two lower support post associated with a lower support rail;

FIG. 5 is a side view of a top rail associated with one upper support post configured to telescopically associate with one lower support post associated with a lower base rail;

FIG. 6 is a top close-up view of a top rail pivotally associated with the peripheral edge of a workbench top and locked into place with two indexing pins;

FIG. 7 is a partial cut away view from perspective (31a) of FIG. 1 revealing one embodiment of an indexing pin;

FIG. 8 is a partial cut away view from perspective (31b) of FIG. 1 revealing one embodiment of a pivot rod pivotally associated with a workbench top and a top rail;

FIG. 9 is a partial cut away view from perspective (41) of FIG. 1 of the work bench top showing the support plate opening and a template guide pin according to one embodiment of the invention;

FIG. 9a is a side view of a template pin;

FIG. 9b is a top view of the template pin in FIG. 9;

FIG. 10 is a partial side view of a motor support structure showing a motor bracket and a motor bracket mover system comprising a force-to-movement-converter associated with a flow controller; and

FIG. 11 is a block diagram representation of a portable transmitter and a controller associated with a signaling device, a motor bracket mover and a display.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

While the particulars of the present invention and associated technology may be adapted for use with any type routing and shaping application on a work piece composed of any type of material (including composite materials), the examples discussed herein are primarily in the context of routing and shaping work pieces for precision woodworking applications.

For the purposes of this document two or more items are “mechanically associated” by bringing them together or into relationship with each other in any number of ways including a direct or indirect physical connection. Similarly, two or more items are “electrically associated” by bringing them together or into relationship with each other in any number of ways including: (a) a direct, indirect or inductive communication connection, and (b) a direct/indirect or inductive power connection. Additionally, while the drawings may illustrate various electronic components of a system connected by a single line, it will be appreciated that such lines may represent one or more signal paths, power connections, electrical connection and/or cables as required by the embodiment of interest.

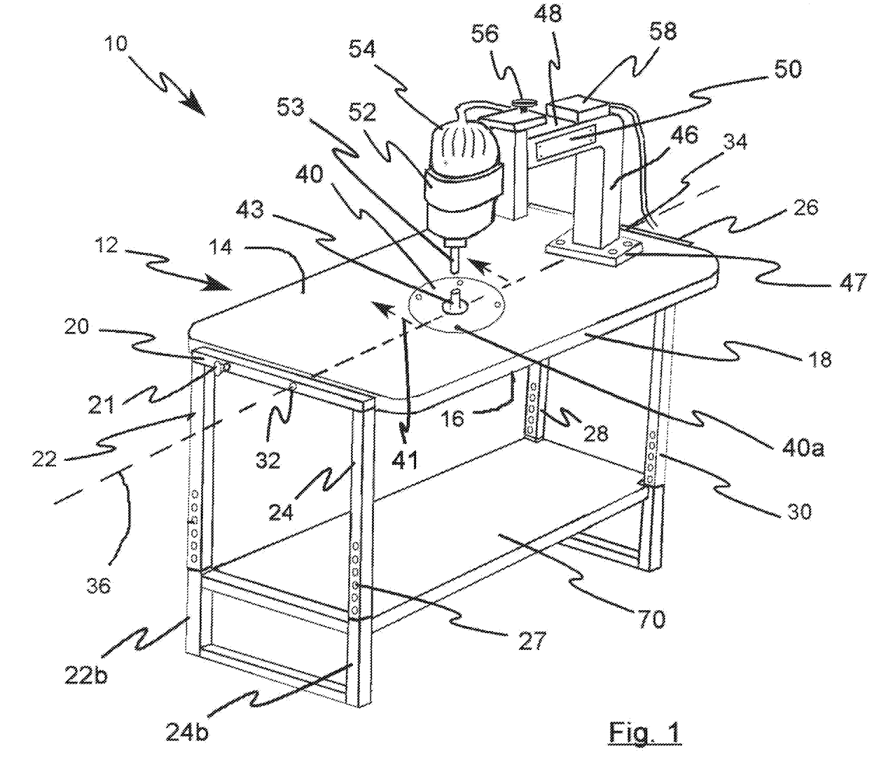

Referring now to FIG. 1, one embodiment of a workbench (10) according to certain aspects of the invention is shown comprising a top (12) defining a pair of opposed faces (14, 16), each face defining a substantially flat plane, each said plane being substantially parallel to the other, top (12) further defining a peripheral edge (18) connecting opposed faces (14, 16). The workbench further comprises a first top rail (20) associated with support legs (22) and (24). Similarly, a second top rail (26) is associated with support legs (28) and (30). For the embodiment shown in FIG. 1, the support legs are substantially equal in height. Support legs (22) and (24) may be further associated with lower support legs (22b) and (24b), and support legs (28) and (30) may be further associated with lower support legs (28b) and (30b). It will be appreciated that such lower support legs are optional.

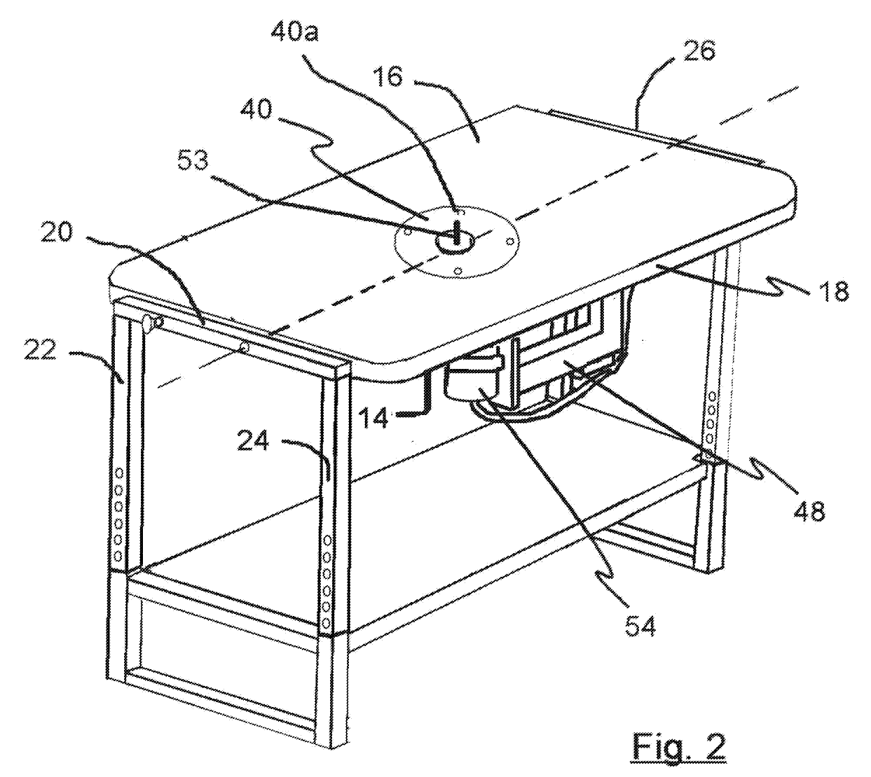

The top (12) is pivotally associated with first top rail (20) at a first peripheral edge location (32) that is about halfway between said opposed faces (14) and (16). Similarly, top (12) is pivotally associated with second top rail (26) at a second peripheral edge location that is about half way between opposed faces (14) and (16). Such a configuration creates a pivot axis (36) about which top (12) may be pivoted allowing top (12) to be selectably positioned in at least two work positions. FIG. 1 depicts an exemplary first work position where top (12) is positioned so that face (14) is above face (16). Additionally, the substantially flat plane defined by face (14) is substantially parallel to top rail (20) and higher than said top rail (20). FIG. 2 shows an exemplary second work position where face (16) is above face (14) and where the substantially flat plane defined by face (16) is substantially parallel to top rail (20) and higher than said top rail (20). Such a configuration allows the work piece to be moved across top (12) without interference from top rails (20) and (26).

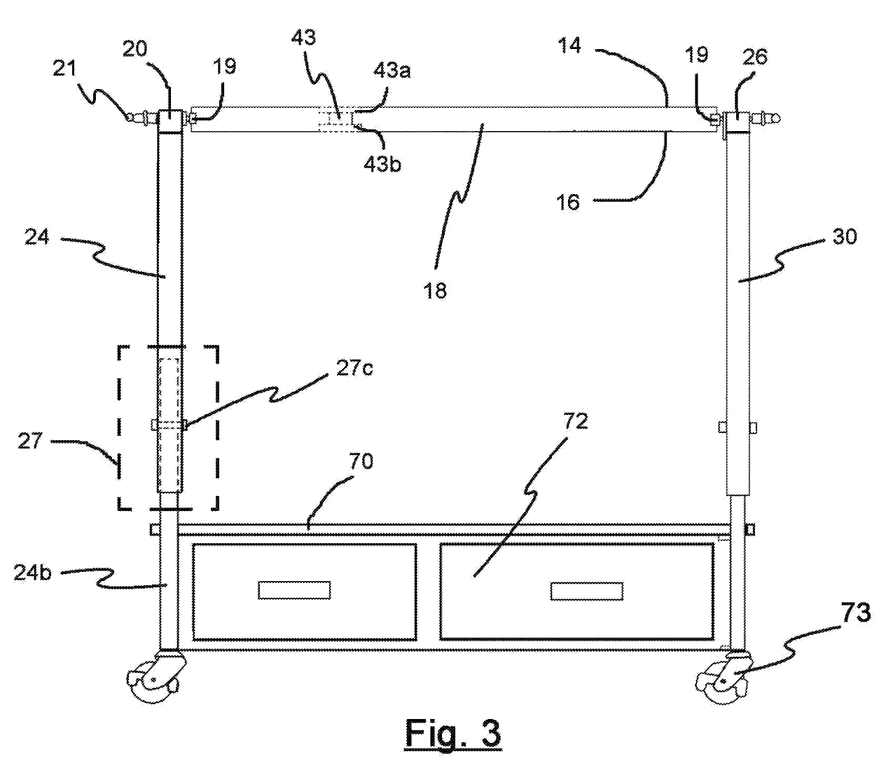

Referring now to FIG. 3, a side view of one possible alternative embodiment of workbench (10) is depicted. For this embodiment, face (14) of top (12) is configured to receive a work tool support structure. The work tool support structure depicted in FIG. 1 is an over arm pin router tool comprising various technologies according the invention (described in detail below). It will be appreciated, however, that the rotating/pivoting table can also be configured to secure previously manufactured bench top over arm pin routers formerly or presently distributed by companies such as Bosch, Porta-Nails, Inc. and Woodstock.

Additionally, in the absence of any type of over arm pin router embodiment, the workbench itself is preferably of sufficient size to be adapted to act as a multi-tool storage bench. For this embodiment, a plurality of power tools can be bolted/fastened to face (14) and face (16) of the top (12) for convenient space saving storage and rapid availability within the workshop. Additionally, for some configurations, top (12) may not comprise a support plate opening.

This embodiment of the invention may further comprise a lower surface (70) defining a pair of opposed faces, each said face defining a substantially flat plane, each said plane being substantially parallel to the other, said lower surface further defining a peripheral edge connecting said opposed faces. The lower surface (70) is associated with said lower support legs (24b) and (30b) so that the faces of said lower surface are substantially parallel to faces of said top (12) when said top (12) is positioned in said first work position and said second work position. As shown in FIG. 3, the lower support legs may further be associated with wheels (73) to facilitate easier relocation of workbench (10). The lower surface (70) may further define the top of at least one storage bin (72) positioned substantially between said lower surface (70) and the second ends (free ends) of said lower support legs (24b) and (30b).

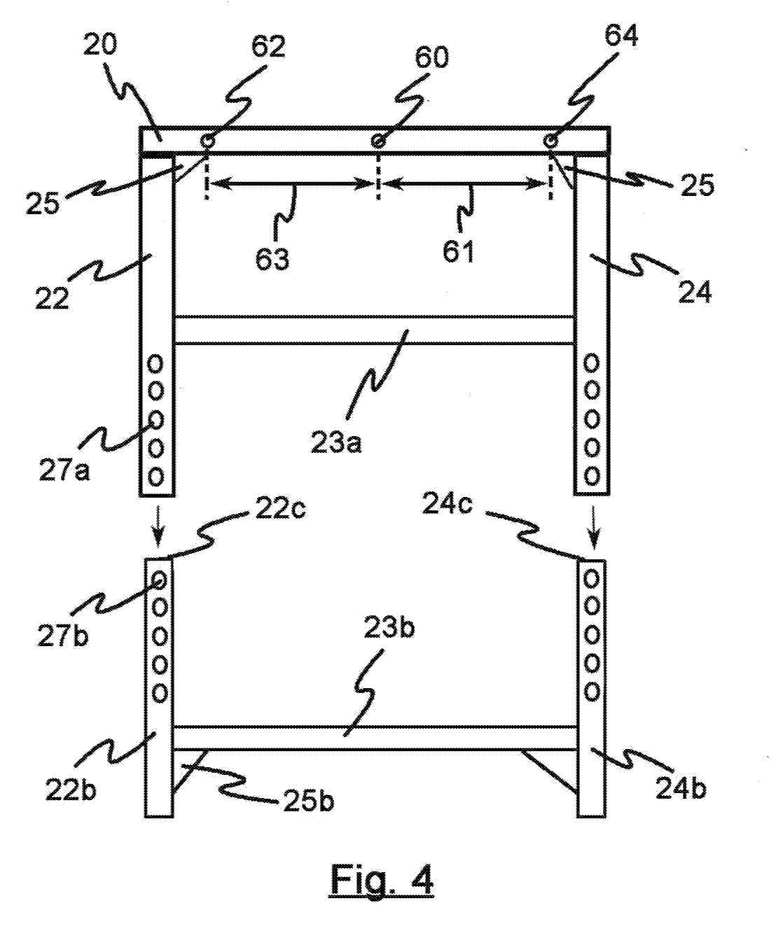

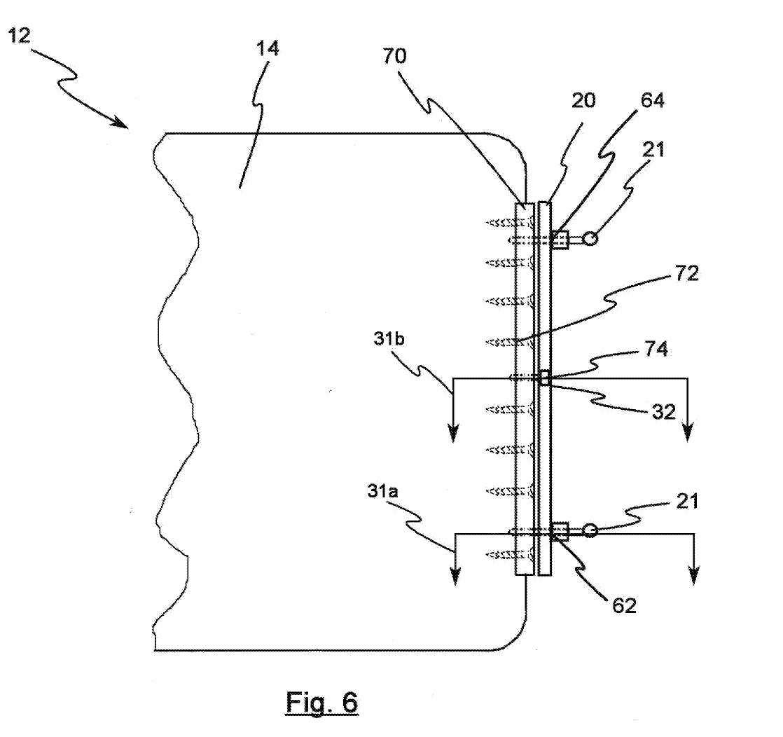

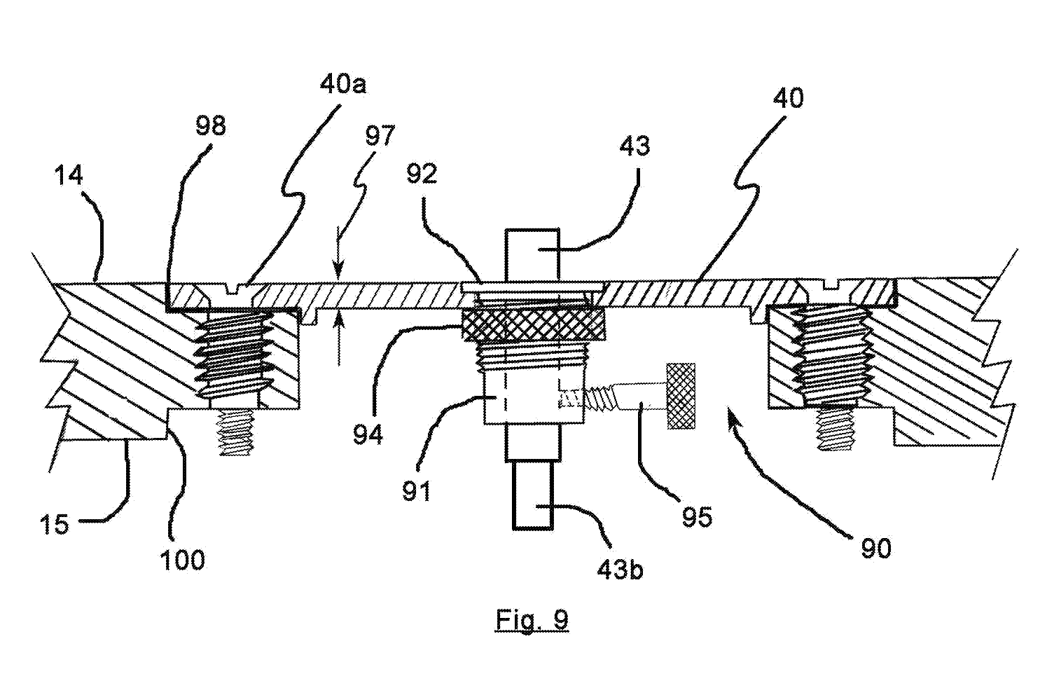

Referring now to FIG. 4, a side view of one exemplary embodiment of a top rail (20) associated with two supports posts is depicted. Top rail (20) comprises a pivot hole (60) configured for receiving a pivot rod (74, FIG. 6, FIG. 8) that extends through top rail (20) and is received by top (12) at a first peripheral edge location about halfway between face (14) and face (16). One of ordinary skill in the art will appreciate that such a configuration allows top (12) to be symmetrically pivoted about pivot axis (36). Top rail (20) further comprises at least one hole for receiving an indexing pin (21). While the FIG. 1 embodiment of the invention comprises only one indexing pin (21), preferably, the workbench (10) comprises a plurality of indexing pins (21). For the embodiment shown in FIG. 4, top rail (20) has two indexing pin holes (62, 64) configured for receiving two indexing pins (described in more detail below). When two indexing pins are used as shown in FIG. 4, the distance (61) between indexing pin hole (64) and pivot hole (60) should be equal to the distance (63) between indexing pin hole (62) and pivot hole (60) so that such indexing pin holes align when top (12) is pivoted between work positions. One of ordinary skill in the art will appreciate that any number of indexing pins (21) may be used without departing from the scope and sprit of the invention.

Still referring to FIG. 4, support legs (22) and (24) are shown associated with top rail (20) in a substantially perpendicular arrangement although other arrangements may be used. One end of support leg (22) is associated with one end of top rail (20) and one end of support leg (24) associated with the other end of top rail (20). Gussets (25) and/or cross member (23a) may be added as needed to improve workbench stability. Such a support structure may be said to form an upside down “U” configuration.

Workbench (10) may further comprise lower support legs (22b) and (24b). For the preferred embodiment, a first end (22c) of lower support leg (22b) is associated with the free end of support leg (22) in a telescopic arrangement. Similarly, a first end (24c) of lower support leg (24b) is associated with the free end of upper support leg (24) in a telescopic arrangement. FIG. 3 shows a side view of telescopic arrangement (27) associated with locking rod (27c). Such a configuration forms an adjustable two support leg configuration. Referring back to FIG. 4, a cross member (23b) and/or gussets (25b) may be added to improve workbench stability.

At least one telescopic arrangement provides a locking point for locking the telescopic arrangement at a desired height thereby providing a means for adjusting the height of top (12). For example, support leg (22) comprises hole (27a) that may be aligned with hole (27b) in lower support leg (22b). A locking rod (27c, FIG. 3) is inserted through holes (27a) and (27b) when such holes are in alignment thereby providing a locking point for positioning top (12) at a desired height. For the preferred embodiment, both telescopic support leg structures comprise a plurality of alignment holes providing a plurality of locking points for positioning top (12) at a plurality of heights. One of ordinary skill in the art will appreciate that top rail (26) may be associated with the same support leg structure configuration described for top rail (20).

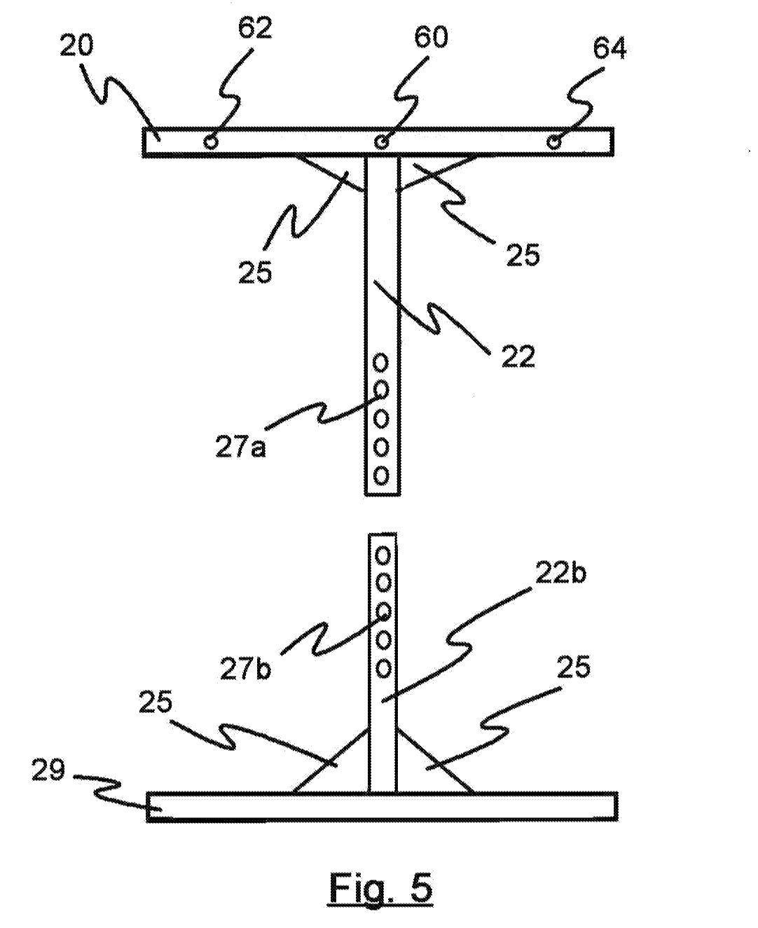

Referring now to FIG. 5, an alternative embodiment for the top rail (20) and the support leg structure is presented. For this embodiment, only one support leg (22) is associated with top rail (20) forming a one-support-leg “T” configuration. Similarly, only one lower support leg (22b) is telescopically associated with support leg (22). Additionally, one end of lower support leg (22b) may be associated with a base rail (29) wherein lower support leg (22b) is substantially perpendicular to base rail (29). One of ordinary skill in the art will appreciate that top rail (26) may also associated with a similar one-support-leg “T” configuration. Alternatively, top rail (26) may be associated with a two support leg configuration as described above while top rail (20) is associated with one-support-let “T” configuration.

Referring now to FIG. 6, a close up top view of one side of top (12) associated with top rail (20) is depicted. For one embodiment of the invention, peripheral edge (18) is configured to receive peripheral edge rail (70). Peripheral edge rail (70) is mechanically associated with peripheral edge (18) with a plurality of screws (72) wherein peripheral edge rail (70) runs substantially parallel to peripheral edge (18). For the preferred embodiment, peripheral edge rail (70) is about the same length as top rail (20) and is configure for receiving indexing pins (21) and pivot rod (74). For the purposes of document, peripheral edge (18) is considered to be receiving indexing pins (21) when indexing pins (21) extend into peripheral edge rail (70), or in configurations without a peripheral edge rail (70), when the indexing pins (21) extend into the peripheral edge (18).

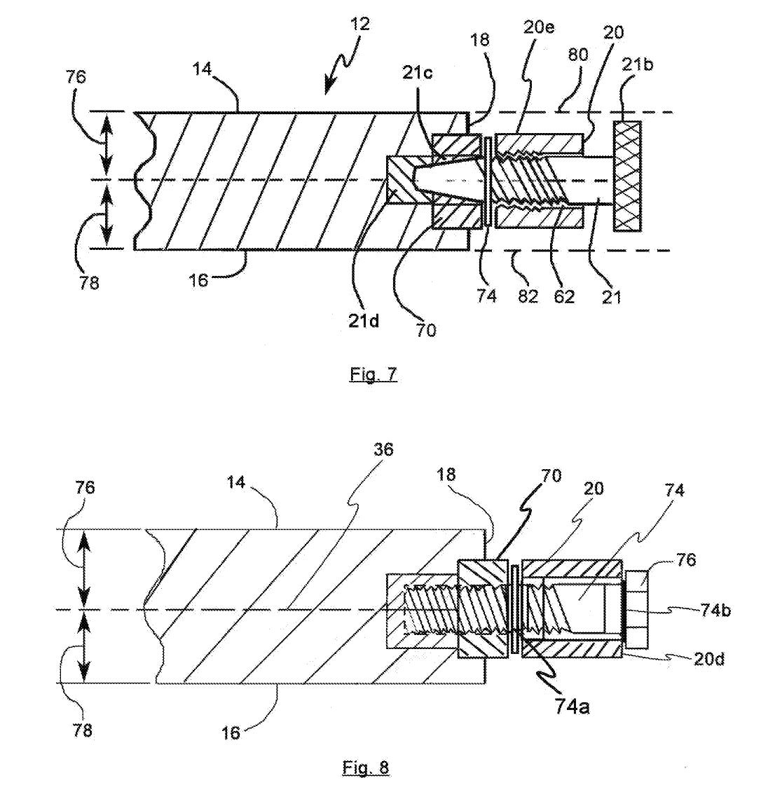

Referring now to FIG. 7, a partial cutaway view of top (12) from perspective 31a of FIG. 6 is presented depicting one possible indexing pin (21), top rail (20), and peripheral edge rail (70) configuration. For the preferred embodiment, indexing pin (21) extends through indexing pin hole (62) in top rail (20) where it is received by the peripheral edge (18) of top (12) via hole (21c) in peripheral edge rail (70) and hole (21d) in peripheral edge (18). Such holes in peripheral edge rail (70) are preferably positioned so that the distance (76) between the center of indexing pin (21) and face (14) and the distance (78) between the center of indexing pin (21) and face (16) are substantially equal. Additionally, the thickness of top (12), (distance 76 plus distance 78), is selected so that the substantially flat plane (80) defined by face (14) is higher than the top side (20e) of top rail (20). It will be appreciated that for such a configuration, the substantially flat plane (82) defined by face (16) will be higher than the top side (20e) of top rail (20) when top (12) is moved to the previously described second work position.

Indexing pin (21) is considered to be in an engaged position and securing top (12) when the indexing pin extends through top rail (20) far enough to be received by a peripheral edge of top (12). For this embodiment of the invention, indexing pin (21) is threaded and is placed in an engaged position by turning indexing pin knob (21b) in a first direction until indexing pin (21) is received by top (12) (as shown in FIG. 7). Indexing pin (21) is disengaged by turning indexing pin knob (21b) in a second direction until indexing pin (21) is no longer received by top (12). Indexing pin (21) may further extend through a washer (74b) positioned between top rail (20) and peripheral edge rail (70) wherein the washer is configured to provide a pivot gap between top rail (20) and peripheral edge rail (70).

One alternative configuration for indexing pin (21) comprises a spring loaded indexing pin where the indexing pin (21) is biased in the engaged position. For such a configuration, indexing pin (21) is disengaged by pulling on indexing pin knob (21b) until indexing pin (21) is no longer received by top (12). To reengage indexing pin (21), top (12) is properly aligned in a desired work position and indexing pin knob (21b) is released. Additionally, for some embodiments of the invention, the spring loaded indexing pin may be configured to lock in the disengaged position allowing the user to release the indexing pin while maintaining the indexing pin in the disengaged mode. Any number of well known technologies may be employed to achieve such functionality including spring loaded tabs.

Referring now to FIG. 8, a partial cut away view of workbench top (12) from perspective 31b of FIG. 6 depicting one embodiment of a pivot rod (74) for pivotally associating the workbench top (12) to a top rail (20). For the preferred embodiment, at least one of top rail (20) and peripheral edge rail (70) receives pivot rod (74) in manner that allows pivot rod (74) to turn about pivot axis (36). For the embodiment depicted in FIG. 7, pivot rod (74) is threaded with peripheral edge rail (70) configured to received the threaded pivot rod while pivot rod (74) is free to turn within top rail (20). Pivot rod (74) may further extend through a washer (74a) positioned between top rail (20) and peripheral edge rail (70) wherein the washer is configured to provide a pivot gap between top rail (20) and peripheral edge rail (70). Pivot rod (74) may further extend through a washer (74b) positioned between top rail side (20d) and peripheral pivot rod head (76) to provide a relatively low friction point between top rail side (20d) and pivot rod head (76).

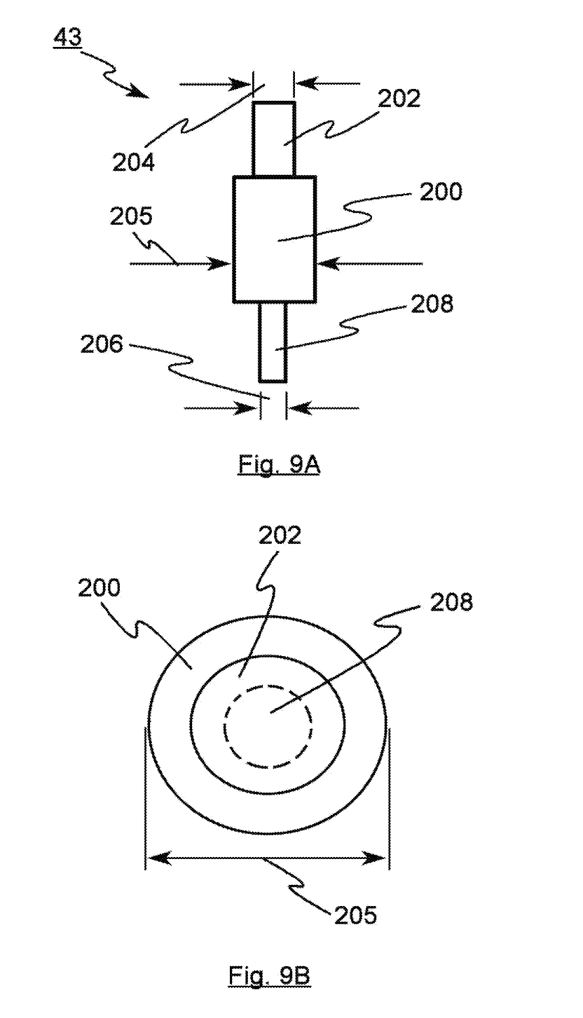

Attention is now directed to the support plate (40) technology according one possible embodiment of the invention. FIG. 9 is a partial cut away view of the work bench top from perspective (41) in FIG. 1. As shown in FIG. 9, top (12) and face (14) further defines a support plate opening (90) having a recessed groove (98) configured for releasably receiving support plate (40). For the preferred embodiment, groove (98) runs the full perimeter of support plate opening (90) with the groove (98) having a depth that is substantially equal to the support plate thickness (97). Support plate (40) is releasably associated with said support plate opening (90) with one or more threaded bolts (40a) so that the surface of support plate (40) is substantially even with face (14) of top (12) thereby creating a substantially flat surface.

Similarly, the support plate opening defined by top (12) may further include a recessed groove (100) relative to face (16) and configured for releasably receiving support plate (40) as described above.

It will be appreciated that any number of well known devices may be used to releasably secure support plate (40) to support plate opening (90) including snaps, screws, and magnetic fields. For one embodiment, support plate (40) may be constructed from a relatively low cost material such as plastic which is secured to top (12) by screws or bolts. For another embodiment, bolts (40a) may be eliminated and the recessed groove (98, 100) of support plate opening (90) may be configured with magnets for securing support plate (40) to support plate opening (90). For such configuration, support plate (40) is composed of a metallic material that magnets are attracted to such as iron, steel, nickel and cobalt.

For the preferred embodiment support plate (40) comprises a predefined opening configured for releasably receiving a template guide pin assembly, although for some embodiments support plate (40) may comprise an integral template guide pin that is not removable. The template guide pin assembly comprises a pin body (91) center portion and an annular pin body top plate (92) integral to the pin body (91) center portion. The pin body (91) extends thorough the predefined opening so that the pin body top plate (92) is received by a recessed groove running along the perimeter of the predefined opening of support plate (40) so that the surface of pin body top plate (92) is substantially even with the support plate surface. For one embodiment of the invention, at least a portion of pin body (91) comprises threads configured for receiving knurled nut (94) for securing the template guide pin assembly to support plate (40).

Support plate (40) is further configured to accommodate a plurality template guide bushings. Template guide bushings are well known by those skilled in the art and a detailed description thereof is not necessary for purposes of describing the method and system according to the present invention.

Pin body (91) and annular pin body top plate (92) further define a pin hole configured for receiving a template guide pin (43). FIG. 9A and FIG. 9B show one exemplary embodiment of template guide pin (43) having a main body (200) associated with guide pin (202) at one end and guide pin (208) at the other end. Guide pin (202) has diameter (204) whereas pin (208) has diameter (206). Preferably diameter (204) is different from diameter (206). Typical guide pin diameters include ⅛, ¼, ⅜, ½, 3/16, 5/16 of an inch. Main body (200) has diameter (205) with is slightly less than the pin hole defined by pin body (91) and annular pin body top plate (92) allowing main body (200) to be adjustably extend through the pin hole and secured in place by bolt (95). Preferably, the position of main body (200) is selected so that that guide pin (200) extends beyond the support plate to a point beyond face (14). With such a configuration, template guide pin (43), for example, may be mated with a groove in a work piece template. Such a configuration guides the work piece template in a predefined pattern as it is moved across top (12).

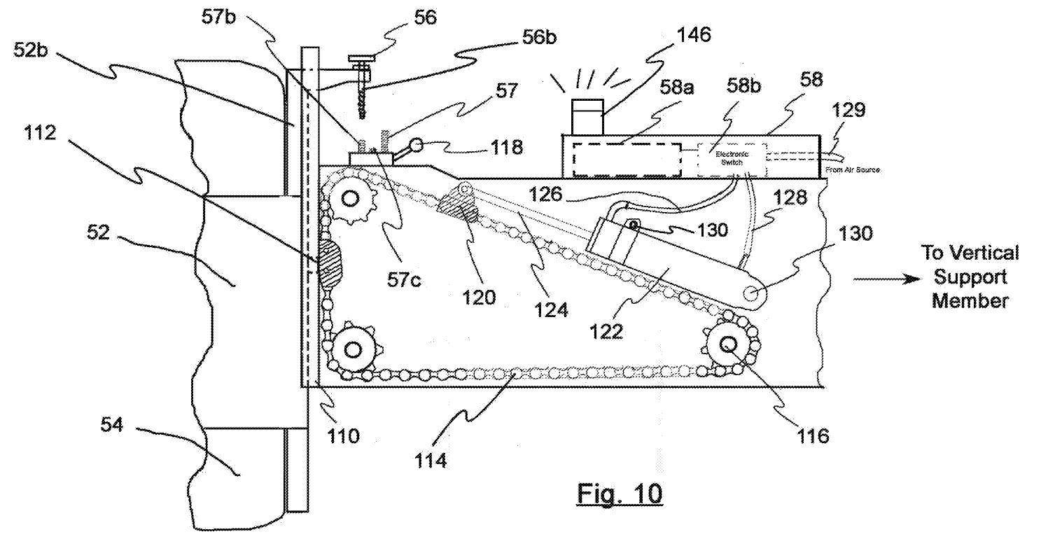

Attention now is directed to the motor support structure and associated technology. FIG. 10 is a partial side view of a motor support structure including a motor bracket (52) associated with a motor bracket mover system (described later). As shown in FIG. 1, the motor support structure includes vertical support (46) that raises substantially perpendicular from the substantially flat plane defined by face (14). Support arm (48) is associated with vertical support (46) at a predetermined distance above face (14). Support arm (48) is substantially parallel to face (14) and extends out from vertical support (46) to a vertical alignment point. For the embodiment depicted in FIG. 1, the vertical alignment point is the point where motor shaft (53) aligns vertically with template guide pin (43). As shown in FIG. 1, the vertical support (46) and the support arm (48) form one integral motor support structure. It will be appreciated, however, that embodiments where vertical support (46) is a separate component that is mechanically associated with support arm (48) falls within the intended scope of the invention.

Attention is now directed to components of the exemplarily motor bracket adjustment system. It should be recognized that the motor bracket adjustment system may comprise a plurality of physically separated but cooperatively associated electronic devices that are not shown independently in some figures, such as a radiofrequency transmitter and receiver, a processor, memory, electronic sensors, one or more display means such as a visual display screen, lights, an audio speaker, and the like, with communications being controlled by a central processing device.

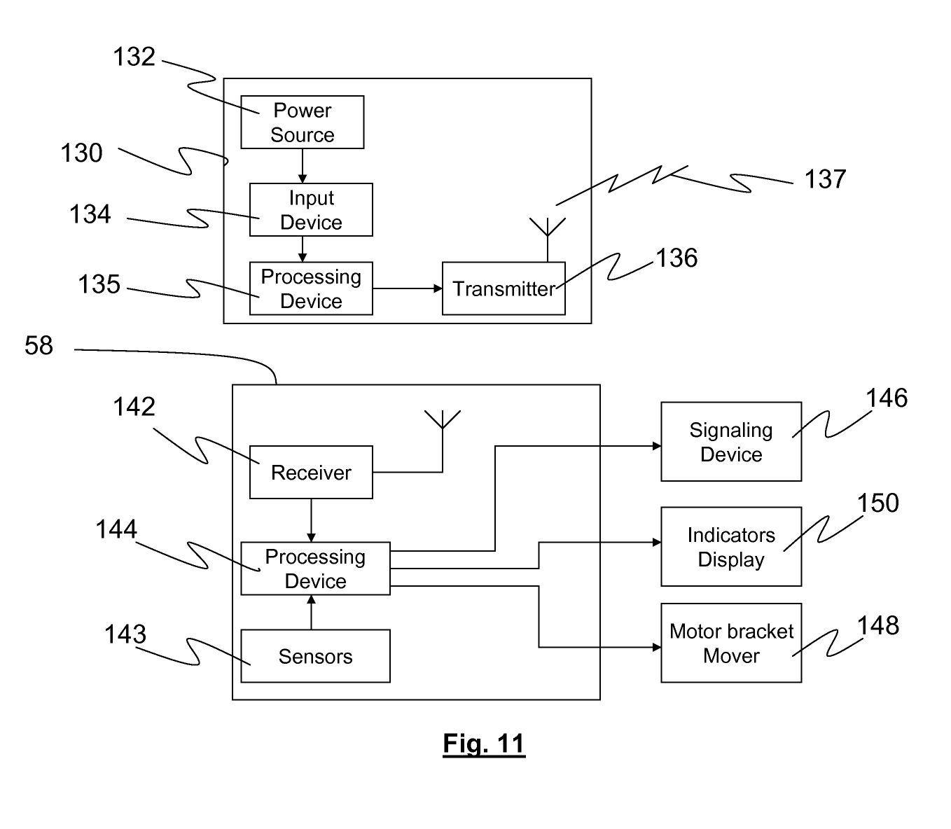

Referring to FIG. 11, the first motor bracket adjustment system component considered is portable transmitter (130). Initially, it should be noted that portable transmitter (130) may be associated with any suitable object including the work piece, a location on the workbench, a work piece carrier, a user, and a work piece template. Work piece carriers and templates are well known in the art. Portable transmitter (130) is configured for receiving user input from input device (134). Input device (134) may be any number of well known devices for receiving user input including one or more switches, a keypad, voice activation interface, and a LCD with touch screen technology. Portable transmitter (130) is powered by power source (132) which may comprise any number of technologies including one or more batteries, an energy converter (such as a photovoltaic device), and a connection to an external power source. Portable transmitter (130) is further configured with transmitter (136) for transmitting a user data signal in response to user input. A user might use portable transmitter (130) in place of a foot pedal, for example, to cause a router motor to “plunge” toward a work piece. It will be appreciated that some embodiments of the motor bracket adjustment system comprises components substantially free of electronics, a foot pedal is used in pace of the portable transmitter thereby offering a substantially mechanical device. Such foot pedal technology is well known in the art.

For one embodiment of the invention, portable transmitter (130) is a simple transmitter (136) configured to transmit a carrier signal at a predefined frequency when a user presses a button associated with portable transmitter (130). Alternatively, portable transmitter (130) may be a relatively more complicated device comprising a processing device configured for receiving and processing user input and transmitting a user data signal in response to at least part of the user input. Suitable transmitter technologies include BlueTooth, Zigbee, and Wi-Fi although any suitable technology or signal format may be used without departing from the scope of the invention. Such technology is known and understood by those skilled in the art, and a detailed explanation thereof is not necessary for purposes of describing the method and system according to the present invention.

The motor bracket adjustment system shown in FIG. 1 and FIG. 10 further comprises controller (58) associated with support arm (48). Referring back to FIG. 11, controller (58) comprises a receiver (142) configured for receiving a transmitted signal such as a transmitted user data signal. Receiver (142) is electrically associated with processing device (144) and configured for transferring at least part of a received signal or at least part of the information contained in such a signal to processing device (144). Processing device (144) is further configured for generating adjustment signals in response to at least part of the information/signal data received from receiver (142). Suitable controller/receiver technology include BlueTooth and Wi-Fi although any signal format and technology may be used as such technology is known and understood by those skilled in the art, and a detailed explanation thereof is not necessary for purposes of describing the method and system according to the present invention.

Alternatively, a wireless electronic switching device may be used for controlling motor bracket movements. The wireless electronic switching device comprises a receiver electrically associated with a switching device. For such a configuration, a separate controller is not required and the transmitted user data signal is received directly by the wireless electronic switching device. One example of a wireless electronic switching device is a Bluetooth enabled pneumatic switch.

As shown in FIG. 11, controller (58) may be further associated with a signaling device (146) electrically associated with processing device (144). One exemplary embodiment of a signaling device (146) is a light as shown in FIG. 10. However, signaling device (146) may comprise any number of technologies suitable for visually and/or audibly signaling a user. Preferably, signaling device (146) comprises at least one of a light emitting element and a sound emitting element. For one embodiment of the invention, processing device (144) is configured to activate signaling device (146) upon receiving a signal from portable transmitter (130) such as a signal to move motor bracket (52). Additionally, processing device (144) may be further configured to wait a predefined period of time after activating signaling device (146) before generating said motor bracket adjustment signals. Such a configuration provides the user with a warning that the motor bracket adjustment system is about to perform an action.

Upon receiving a warning signal, the user may take any number of actions depending on the motor bracket adjustment system control configuration. For one configuration, (push and hold configuration), portable transmitter (130) has a “plunge” button that a user presses for the entire duration in time the users desires the motor bracket to move (or stay) in the plunge direction. When a user wishes to disengage a tool, the user simply releases the “plunge” button. Consequently, for this configuration, the user may simply releases the “plunge” button before the motor bracket adjustment system activates (or during movement) to abort the motor bracket (52) movement.

For a second control configuration, (push and release configuration), a user presses and releases a plunge button to cause the motor bracket (52) to plunge or move in the plunge direction. The motor bracket (52) continues to move in the plunge direction until it reaches a mechanical limit and remains in the plunge position until the user presses a “unplunge” button. Notably, the plunge and unplunge button may be the same button. For this configuration, the user may simply press the “unplunge” button before (or during) the motor bracket adjustment system activates to abort the motor bracket (52) movement. It will be appreciated that any number of motor bracket adjustment system control configurations may be used with out departing from the scope and spirit of the invention.

Attention now is directed to the display device (150) that may be electrically associated with processing device (144) for displaying system information. Any type of display devices (150) may be used including simple lights and relatively complex LCD displays. Such technology is known and understood by those skilled in the art, and a detailed explanation thereof is not necessary for purposes of describing the method and system according to the present invention. Displayable system information will be limited by the display technology used, however, for the purposes of this document, system information may be any kind of information including system settings (e.g. movement settings, movement limit settings, speed settings, etc.), sensor data (e.g. bit temperature, environment data), system diagnostic data (e.g. battery power level of the controller and/or transmitter, signal strength, electronic component health, etc.), and time data (e.g. elapsed time data, current time data, etc.). Environment data includes temperature, humidity, barometric pressure or any other measurement associated with the environment surround the workbench.

As shown in FIG. 11, sensors (143) may be electrically associated with processing device (144) for generating sensor data. Any type of sensor may be associated with processing device (144) that is appropriate for the sensor application of interest including temperature sensors, time trackers (chronographs/stop watch/job timer, etc.), humidity sensors, moisture sensors and speed sensors. Such technology is known and understood by those skilled in the art, and a detailed explanation thereof is not necessary for purposes of describing the method and system according to the present invention.

Attention is now directed to the mechanical components of the motor bracket adjustment system. In FIG. 10, cover plate (50) (FIG. 1) associated with support arm (48) has been removed showing parts of a motor bracket adjustment system. For this embodiment of the invention, processing device (144) housed in box (58a) is electrically associated with electronic switch (58a). Electronic switch (58a) is mechanically associated with a motor bracket mover via pneumatic lines (126) and (128) associated with pneumatic cylinder (122). For the purposes of this embodiment of the invention, it is not important if the electronic switch (58a) is considered a component of the controller or a component of the motor bracket mover. The motor bracket mover is further mechanically associated with motor bracket (52) and said support arm (48) as described later. The motor bracket mover is configured to move motor bracket (52) depending on the state of electronic switch (58b) and wherein the state of the electronic switch (58b) is determined by adjustment signals generate by processing device (144). Electronic switch (58b) is one possible embodiment of a flow controller. Such functionally is described in more detail below for one particular embodiment of the motor bracket mover.

For the embodiment depicted in FIG. 10, the motor bracket mover includes pneumatic cylinder (122) mechanically associated with chain (114) by chain clamp (120). Pneumatic cylinder (122) is one exemplary embodiment of a force-to-movement-converter configured for receiving a substance that flows into the force-to-movement-converter. For the embodiment shown in FIG. 10, the substance is air. Pneumatic cylinder (122) is further mechanically associated with support arm (48) via fasteners (130). Chain (114) is mechanically associated with vertical plate (52b) by a second chain clamp (112). Vertical plate (52b) is mechanically associated with motor bracket (52) and is movably associated with support arm plate (110). Support arm plate (110) is mechanically associated with support arm (48). Preferably, vertical plate (52b) is slidably associated with support arm plate (110) in a dove tail configuration so that vertical plate (52b) may be moved vertically up and down by pneumatic cylinder (122) thereby adjusting the distance between said motor bracket (52) and top (12).

Thus, for the above described configuration, the force created by the air flowing into or out of pneumatic cylinder (122) is converted into a movement that is transferred to chain (114) which in turn moves said motor bracket (52) either vertically up or vertically down. It will be appreciated, however, that motor bracket (52) may be configured to move in any number of directions, however, for the embodiment depicted in FIG. 10, motor bracket (52) movers vertically upward or vertically downward depending on the state of electronic switch (58b) as the state of electronic switch (58b) determines the flow pattern of the air flowing through the system. For the purposes of this document, the term “flow pattern” refers to the flow attributes describing the flow of a substance, such attributes including flow path, flow direction, and flow rate.

A more detailed description of the pneumatic configuration for the disclosed embodiment is now presented. Pneumatic cylinder (122) comprises a first pneumatic connection (126) and a second pneumatic connection (128). Electronic pneumatic switching device (58b) is pneumatically associated with first pneumatic connection (126), second pneumatic connection (128) and air source. Electronic pneumatic switching device (58b) is further electrically associated with processing device (144). For the preferred embodiment, electronic pneumatic switching device (58b) is configured for selectively connecting the air source to one of said first pneumatic connection (126) and said second pneumatic connection (128) in response to the adjustment signals generated by processing device (144). Thus, switching device (58b) is one embodiment of a flow pattern controller that that alters the flow pattern of the air through the motor bracket mover based on adjustment signals received by processing device (144).

For example, pneumatic cylinder (122) is mechanically associated with motor bracket (52) via chain (114). When a user wishes to lower (“plunge”) the motor toward the work piece, the user presses a “plunge” button on portable transmitter (130). Portable transmitter (130) generates and transmits a control signal (or user data signal) which is received by receiver (142). Receiver (142) transfers at least part of the signal or information associated with the signal to processing device (144). Processing device (144) in turn generates adjustment signals that will result in a “plunge” action and transfers the adjustment signals to electronic pneumatic switching device (58b) which connects the air source to second pneumatic connection (128) which cause cylinder rod (124) to move in the plunge direction. Chain (114) then moves in the counter clockwise direction causing motor bracket (52) to move vertically downward.

The motor bracket adjustment system may further comprise a motor bracket movement limiter. Preferably, the motor bracket movement limiter has a plurality of manually or electronically selectable movement limit settings. For the embodiment shown in FIG. 10, the movement limit settings are determined by which vertical limit post (57, 57b, 57c) is in alignment with vertical stop adjustor (56b) associated with vertical plate (52b). It will be appreciated that any number of limits settings may be utilized without departing from the scope of the invention.

For manual system, vertical limit posts (57, 57b, 57c) are associated together in a turret configuration with the turret arm (118) used to select which vertical limit post aligns with vertical stop adjustor (56b).

For electrically selectable limit setting configurations, the motor bracket movement limiter is mechanically associated with the bracket mover as described above and is also electrically associated with processing device (144) via an electronic limit selector. The electronic limit selector is configured to set the movement limiter setting in response to adjustments signals received from processing device (144). Electronic limit selector may comprise any technology suitable for mechanically selecting a vertical limit post in response to electronic commands generated by processing device (144). For example, the electronic limit selector may comprise an electronic motor configured to respond to said adjustment signals and mechanically move the desired vertical limit post in alignment with stop adjustor (56b). Such technology is known and understood by those skilled in the art, and a detailed explanation thereof is not necessary for purposes of describing the method and system according to the present invention.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. An apparatus for routing and shaping a work piece, said apparatus comprising:
a top defining a pair of opposed faces, each said face defining a substantially flat plane, each said plane being substantially parallel to the other, said top further defining a peripheral edge connecting said opposed faces;
a first top rail associated with at least one support leg and a second top rail associated with at least one support leg, wherein said support legs are substantially equal in height;
wherein said top is pivotally associated with said first top rail at a first peripheral edge location that is about half way between said opposed faces;
wherein said top is pivotally associated with said second top rail at a second peripheral edge location that is about half way between said opposed faces;
wherein said top is selectably positionable in at least one of a first work position and a second work position;
wherein the substantially flat plane defined by one of said opposing faces is substantially parallel to a top rail and higher than said top rail when said top is in said first work position and wherein the substantially flat plane defined by the other face is substantially parallel to said top rail and higher than said top rail when said top is in said second work position;
wherein said top further defines a support plate opening configured for releasably receiving a support plate;
a support plate releasably associated with said support plate opening, said support plate comprising one of (a) a template guide pin and (b) a predefined opening configured for releasably receiving a template guide pin assembly comprising a guide pin, wherein said template guide pin extends from said support plate to a point beyond said face;
a motor support structure associated with a face of said top, said motor support structure comprising a support arm wherein said support arm is substantially parallel to said face and extends from said support structure to an vertical alignment point;
a motor bracket movably associated with said support arm;
a motor bracket adjustment system associated with said motor bracket and said support arm, said motor bracket adjustment system configured for moving the motor bracket; and
a motor associated with said motor bracket and configured for receiving at least one of a routing element and a shaping element.

2. An apparatus for routing and shaping a work piece as in claim 1, wherein substantially all of the motor bracket adjustment system's mechanical components are enclosed in said support arm to minimize the vertical profile of the adjustment system.

3. An apparatus for routing and shaping a work piece as in claim 1, where in said motor bracket adjustment system comprises a pneumatic cylinder mechanically associated with said motor bracket and said support arm and wherein the movement of the pneumatic cylinder is controlled by a pneumatic foot pedal.

4. An apparatus for routing and shaping a work piece as in claim 1, further comprising an indexing pin configured for releasably engaging said peripheral edge thereby holding said top in a work position.

5. An apparatus for routing and shaping a work piece as in claim 1, wherein said motor bracket adjustment system comprises:
a portable transmitter configured for receiving user input and transmitting a user data signal in response to at least part of said user input;
a controller comprising a receiver configured for receiving a signal from said portable transmitter;
wherein the controller further comprises a processing device electrically associated with said receiver and configured for generating adjustment signals in response to at least part of a received user data signal;
a motor bracket mover mechanically associated with an electronic switch, wherein said electronic switch is electrically associated with said processing device;
wherein said motor bracket mover is further mechanically associated with said motor bracket and said support arm; and
wherein said motor bracket mover is configured to move said motor bracket depending on the state of said electronic switch, and wherein the state of the electronic switch is determined by said adjustment signals.

6. An apparatus for routing and shaping a work piece as in claim 5, wherein said motor bracket adjustment system further comprises a motor bracket movement limiter;
wherein said motor bracket movement limiter is mechanically associated with said motor bracket mover and electrically associated with said processing device;
wherein said motor bracket movement limiter has a plurality electronically selectable movement limit settings; and
wherein the motor bracket movement limiter setting is determined by said adjustment signals.

7. An apparatus for routing and shaping a work piece as in claim 5, wherein said motor bracket mover comprises:
a pneumatic cylinder comprising a first pneumatic connection, a second pneumatic connection, said pneumatic cylinder mechanically associated with said motor bracket and said support arm;
wherein said electronic switch is an electronic pneumatic switching device electrically associated with said processing device and pneumatically associated with said first pneumatic connection, said second pneumatic connection, and an air source; and
wherein said electronic pneumatic switching device is configured for selectively connecting said air source to one of said first pneumatic connection and said second pneumatic connection in response to said adjustment signals.

8. An apparatus for routing and shaping a work piece as in claim 5, wherein said portable transmitter is associated with at least one of (a) a work piece carrier, (b) a user, and (c) a work piece template.

9. An apparatus for routing and shaping a work piece as in claim 5, wherein said motor bracket adjustment system further comprises a display electrically associated with said processing device.

10. An apparatus for routing and shaping a work piece as in claim 5, further comprising a signaling device electrically associated with said processing device, said signaling device comprising at least one of (a) a light emitting element, and (b) a sound emitting element.

11. An apparatus for routing and shaping a work piece as in claim 10, wherein said processing device is further configured activate said signaling device a predefined period of time before generating said adjustment signals.

12. An apparatus for routing and shaping a work piece as in claim 11, wherein said controller further comprises a display configured for indicating the motor bracket movement limiter setting.

13. A workbench comprising:
a top defining a pair of opposed faces, each said face defining a substantially flat plane, each said plane being substantially parallel to the other, said top further defining a peripheral edge connecting said opposed faces;
a first upper support leg and a second upper support leg with each upper support leg having a first end and a second end;
a first top rail associated with the first end of said first upper support leg wherein said top is pivotally associated with said first top rail at a first peripheral edge location that is about half way between said opposed faces;
a second top rail associated with the first end of said second upper support leg wherein said top is pivotally associated with said second top rail at a second peripheral edge location that is about half way between said opposed faces;
wherein said top is selectably positionable in at least one of a first work position and a second work position;
wherein the substantially flat plane defined by one of said opposing faces is substantially parallel to a top rail and higher than said top rail when said top is in said first work position and wherein the substantially flat plane defined by the other face is substantially parallel to said top rail and higher than said top rail when said top is in said second work position;
wherein said top further comprises a support plate opening defining a hole there through, said support plate opening configured for releasably receiving a support plate; and
a support plate releasably associated with said support plate opening, said support plate comprising one of (a) a template guide pin and (b) a predefined opening configured for releasably receiving a template guide pin.

14. A workbench as in claim 1, further comprising:
a first lower support leg and a second lower support leg, said lower support legs having a first end and a second end;
wherein the first end of said first lower support leg is associated with the second end of said first upper support leg in a telescopic arrangement and wherein the first end of said second lower support leg associated with the second end of said second upper support leg in a telescopic arrangement;
wherein at least one of said telescopic arrangements is configured with at least one locking point for adjusting the height of said top;
a lower surface defining a pair of opposed faces, each said face defining a substantially flat plane, each said plane being substantially parallel to the other, said lower surface further defining a peripheral edge connecting said opposed faces;
wherein said lower surface is associated with said lower support legs so that the faces of said lower surface are substantially parallel to the faces of said top when said top is positioned in said first work position and said second work position; and
said lower surface further defining the top of at least one storage bin positioned between said lower surface and said second ends of said lower support legs.

15. A wireless motor movement controller for controlling the movements of a motor associated with a workbench, said wireless motor movement controller comprising:
a portable transmitter configured for receiving user input and transmitting a control signal in response to said user input;
a motor support structure having an workbench interface configured for associating said motor support structure to the top of a workbench;
a motor bracket configured for receiving a motor wherein said motor bracket is movably associated with said support structure;
a motor bracket mover system comprising a force-to-movement-converter configured for receiving a substance that flows into the force-to-movement-converter, said substance creating a force within the force-to-movement-converter that is converted into a movement that moves said motor bracket in one of a plurality of directions and wherein the direction of movement is determined by the substance's flow pattern;
a receiver electrically associated with a processing device and configured for receiving said control signal and transfer at least part of said control signal to said processing device;
wherein said processing device is configured for generating motor bracket adjustment signals in response to at least part of said control signal; and
a flow controller electrically associated with said processing device and mechanically associated with a source for providing said substance and wherein said flow controller is configured for controlling the flow pattern of said substance in response to at least part of said motor bracket adjustment signals.

16. A wireless motor movement controller as in claim 15, wherein said substance is one of: (a) electrons, (b) a gas, and (c) a fluid.

17. A wireless motor movement controller as in claim 15, wherein said motor bracket mover system comprises a chain in mechanical communication with said force-to-movement-converter and said motor bracket.

18. A wireless motor movement controller as in claim 15, further comprising a signaling device electrically associated with said processing device, said signaling device comprising at least one of (a) a light emitting element, and (b) a sound emitting element.

19. A wireless motor movement controller as in claim 18, wherein said processing device is further configured to activate said signaling device and wait a predefined period of time after activating said signaling device before generating said motor bracket adjustment signals.

20. A wireless motor movement controller as in claim 15, wherein said portable transmitter technology and said receiver technology comprise one of (a) Bluetooth technology and (b) Wi-Fi technology.

21. A wireless motor movement controller as in claim 15, further comprises a display electrically associated with said processing device and configured for displaying system information.
